(19) United States
(12) Patent Application Publication
(10) Pub. No.: US 2026/0274590 A1
(43) Pub. Date: Sep. 17, 2026

(54) SAFE TRANSITION FOR CONVEYOR SYSTEMS

(71) Applicant: Gerhard Schubert GmbH, Crailsheim (DE)

(72) Inventors: Harald Mikusch, Crailsheim (DE); Rolf Bögelein, Crailsheim (DE); Peter Schubert, Crailsheim (DE)

(73) Assignee: Gerhard Schubert GmbH, Crailsheim (DE)

(21) Appl. No.: 19/562,247

(22) Filed: Mar. 10, 2026

(30) Foreign Application Priority Data
Mar. 14, 2025 (DE) 10 2025 109 894.8

(51) Int. Cl. B65G 47/66; B65G 23/24

(52) U.S. Cl. CPC B65G 47/66; B65G 23/24; B65G 2207/40

(57) ABSTRACT

The present application relates to a transport device with a transport means for transporting objects along a transport path, wherein the transport means has at least one contact surface which is designed to contact an object and to entrain it along the transport path, wherein the transport device is designed to permit an evasive movement of the transport means along a release path deviating from the path of movement of the transport means when a force acts on the transport means which exceeds a predetermined release force.

### CROSS REFERENCE TO RELATED APPLICATION

This application claims priority to German Patent Application No. 10 2025 109 894.8, filed in Germany on Mar. 14, 2025, the entire contents of which are hereby incorporated herein by this reference.

### FIELD

The present application relates to a transport device with a transport means for transporting objects along a transport path, wherein the transport means has at least one contact surface which is designed to contact an object and carry it along the transport path.

### BACKGROUND

Such transport devices are usually used as part of production systems and/or sorting systems, for example, and are used to transport objects between different processing stations, for example. Transport devices can, for example, be adjacent to processing areas such as a table, a tray or a machine for processing. In addition, several transport devices are often combined on one transport route. This results in interfaces between successive transport devices and/or processing areas at which an object to be transported is transferred from one transport device or processing area to a subsequent transport device or processing area. At such a transition, a transport means of a transport device is usually arranged close to the transport means of an adjacent transport device or close to an adjacent processing area in order to keep a gap between them small and, for example, to reduce a risk of damage to the object at the transition. However, a correspondingly small dimensioning of the gap also results in risks. In particular, there is a risk of injury for a person in the vicinity of the transport devices if they are caught by a means of transportation and trapped in the space between them. An object or foreign body can also be caught and jammed in the gap, so that the transport device and/or processing area or jammed objects can be damaged.

To counteract such risks, the prior art includes, for example, a shut-off device that stops a means of transportation of a transport device if an entrapment is detected in the gap. However, such a shutdown can generally only limit the extent of injuries and/or damage, but not prevent entrapment from the outset. The approach of minimizing the gap as much as possible is also known from the prior art, in particular to prevent a person from reaching into the gap with limbs, for example, and being injured here. However, reducing the gap is only possible to a limited extent and cannot prevent hair, clothing and/or fingers from being caught and trapped, for example.

### SUMMARY

Against this background, it was the task of the present invention to provide a transport device for transporting objects along a transport path, which addresses the disadvantages of the known solutions. This is intended to minimize the risk of people and/or objects in particular becoming trapped between a means of transport of a transport device and an adjacent transport device or an adjacent processing area, as well as the effects in the event of trapping, i.e. in particular injuries and damage.

According to a first aspect of the invention, the aforementioned problem is solved by a transport device for transporting objects along a transport path, comprising a carrier having a mounting portion adapted to hold or support the transport device on a superordinate structure, a transport means movably mounted on the carrier so that it performs a movement along a defined cyclic movement path, the transport means having at least one contact surface adapted to contact and entrain an object along the transport path, the transport device being adapted to perform an evasive movement of the object along the transport path, cyclic movement path, wherein the transport means has at least one contact surface which is adapted to contact an object and to entrain it along the transport path, wherein the transport device is adapted to allow an evasive movement of the transport means along a release path deviating from the movement path of the transport means when a force acts on the transport means which exceeds a predetermined release force.

According to an important feature of this aspect, the transport device is designed to allow an evasive movement of the transport means along a release path deviating from the movement path of the transport means when a force acts on the transport means that exceeds a predetermined release force. Such an evasive movement has the effect, for example, that the maximum force acting on a person and/or an object is preferably limited to the predetermined release force. The evasive movement of the transport means can be achieved in particular by moving the transport device as a whole and/or by moving the transport means relative to other components of the transport device. In particular, an evasive movement can advantageously comprise a rotation and/or a displacement of the transport device and/or the transport means. Preferably, an evasive movement can take the form of a displacement approximately horizontally and/or approximately vertically, preferably upwards, and can in particular be superimposed with a rotation. Advantageously, the release force can be predetermined in such a way that the transport device enables stable and safe transportation of objects along the transport path under conventional operating conditions. An application of force can arise, for example, by actuating the transport means itself when a person and/or an object is in engagement with the contact surface of the transport means, in particular when it and/or the object is jammed between the transport means and an adjacent device, in particular another transport device and/or a processing area, such as a table, a tray or a machine for processing, and/or when the person and/or the object is pressed against the transport device from the outside, in particular in the event of jamming. By deviating the release path from the path of movement of the means of transport, it is ensured in particular that the application of force is interrupted and/or reduced. In particular, the application of force is prevented from causing injury to the person and/or damage to the means of transport, the transport device, the object to be transported and/or other devices.

The transport means is preferably a circulating conveyor belt whose movement path is defined by at least two spaced deflection means around which the conveyor belt circulates. In particular, such a conveyor belt defines a continuous contact surface. A conveyor belt can, for example, have a belt-like design and, in particular, be made of textile material, plastic and/or metal. It can also be formed in a chain-like manner, wherein in particular a plurality of chain-link-like elements are articulated to one another in such a way that they define a circulating conveyor belt. A conveyor belt usually has the advantage that no objects or people can get caught in it unexpectedly, especially if the contact surface is formed by a continuous material.

The transport means can preferably comprise at least one drum and/or roller, in particular a plurality of drums and/or rollers. A drum and/or roller is mounted on the carrier of the transport device so that it can rotate about an axis of rotation. In particular, adjacent drums and/or rollers, which are preferably arranged parallel and/or closely adjacent, jointly define a transport surface along which the transport path runs over the adjacent drums and/or rollers. Drums and/or rollers can be mounted to rotate freely around the axis of rotation and/or be driven to rotate in order to generate propulsion for objects to be transported.

Advantageously, the transport device can comprise several of the aforementioned embodiments of transport means.

Preferably, the mounting portion is adapted to maintain a holding engagement between the transport device and a higher-level structure when a force acting on the mounting portion is less than a predetermined holding force of the mounting portion, and to release the holding engagement when a force acting on the mounting portion is greater than the predetermined holding force of the mounting portion. Such a superordinate structure can be, for example, a frame, a strut, a housing part, in particular of another device, and/or a wall. In particular, a fastening section can be provided on the superordinate structure, with which the mounting section of the transport device is or can be engaged. Preferably, the transport device and/or the mounting section can be arranged below, above and/or next to the superordinate structure and/or the fastening section of the superordinate structure. The predetermined holding force corresponds in particular to the predetermined release force and the force acting on the mounting section is preferably caused by the force acting on the transport means. Such an embodiment of the invention is particularly advantageous if the evasive movement is to take place as a movement of the transport device as a whole and/or of the transport means together with components of the transport device supported by the assembly section.

In an embodiment of the first aspect, the mounting section has at least one magnet arrangement. Such a magnet arrangement can, for example, comprise permanent magnets and/or electromagnets. In particular, if an electromagnet is included, the transport device may be connected to an external electrical power source and/or include an internal electrical power source such as a battery to power the electromagnet. Such permanent magnets and/or electromagnets are preferably set up to interact, for example, with the superordinate structure, preferably with an attachment section of the superordinate structure, with external magnets and/or external electromagnets and/or a magnetizable section, in particular a magnetizable section of the superordinate structure and/or the attachment section of the superordinate structure. The magnet arrangement can be defined in particular by a section of the mounting section which is set up to interact magnetically and/or electromagnetically, in particular with an external permanent magnet and/or external electromagnet which is provided, for example, on the superordinate structure and/or the fastening section of the superordinate structure. In embodiments in which permanent magnets are provided, these have the advantage that they can cause a magnetic force through magnetic interactions, which can be determined, for example, by a preselectable magnetic strength of the permanent magnet in such a way that a constant predetermined triggering force can be set. In embodiments in which electromagnets are provided, these have the advantage that they can cause a specifically controllable electromagnetic force through electromagnetic interactions, with which a predetermined triggering force can be set up and varied at any time. In particular, a combination of permanent magnets and electromagnets is advantageous for selectively influencing the release force. For example, an electromagnet can be set up to allow and/or cause the evasive movement of the transport means in a controlled manner, for example by varying the electromagnetic forces caused by the electromagnet. For example, a holding engagement between the mounting section of the transport device and the higher-level structure can be specifically canceled by deactivating the electromagnet or reversing its magnetic field.

In an embodiment of the first aspect, the mounting portion comprises a spring mechanism, a rubber band mechanism, a snap mechanism and/or a clamping mechanism. Such mechanisms are particularly suitable for holding the transport device in a normal position on the superordinate structure and, if a force is applied to the transport means that exceeds a predetermined trigger force, allowing the transport means to move out of the way. In particular, the mounting section has a coupling point. In particular, a spring of a spring mechanism and/or a rubber band of a rubber band mechanism can be attached to such a coupling point. The spring of the spring mechanism and/or the rubber band of the rubber band mechanism can also be attached to a coupling point of the superordinate structure so that, for example, a restoring force acts between the coupling points of the mounting section and the superordinate structure. For example, the release force can be adjusted via the spring strength of the spring and/or the elasticity of the rubber band. In particular, such a coupling point of the mounting section may, for example, be part of a snap mechanism and/or a clamping mechanism and may, in particular, engage with a coupling point on the superordinate structure, which is preferably part of a counterpart of the snap mechanism and/or the clamping mechanism arranged on the superordinate structure. For example, the release force can be adjusted via the strength of such an intervention.

Advantageously, the assembly section can comprise several of the aforementioned embodiments.

In an embodiment of the first aspect, a holding force of the mounting section is generated partially or substantially completely by a weight force of the transport device. Particularly in embodiments in which the mounting section is arranged above the superordinate structure and/or the fastening section of the superordinate structure, the weight force of the transport device can cause an inertia force which is of the same order of magnitude as the desired release force. It may then be advantageous to effect no or an optional additional holding force between the transport device and/or the mounting section of the transport device and the superordinate structure, so that the effects of weight force and optional additional holding force complement each other to form the predetermined release force. The holding force can be increased, for example, by using magnets, a spring mechanism, a rubber band mechanism, a snap mechanism and/or a clamping mechanism as described above.

Another embodiment of the first aspect further comprises at least one drive engagement portion adapted to engage with an external drive element to transmit drive force from the external drive element to the transport means. In particular, a drive of the transport means is interrupted when the drive engagement section is moved, preferably together with the transport means, during an evasive movement of the transport means, so that the engagement of the drive engagement section with the external drive element is canceled. Such an embodiment offers the advantage, for example, that no additional control system needs to be provided for an automatic switch-off function. In one embodiment, drive power can be transmitted to the means of transport in the form of mechanical force. In particular, the drive engagement section can engage with the external drive element in a force-fit or form-fit manner. Preferably, such a drive engagement section and such an external drive element are each designed as gear wheels, in particular the external drive element as a worm drive, which are in engagement when the transport device is held or supported on the superordinate structure. In a further embodiment example, drive power can be transmitted to the means of transport in the form of electrical energy, in particular wherein the drive engagement can comprise electrical contacts which are set up to receive drive power in the form of electrical energy from an external drive element, in particular from an electrical energy source. Furthermore, in this alternative embodiment, the transport device may comprise an electric motor which is arranged to be operated by means of this electrical energy and to drive the transport means for movement along the path of movement.

According to a second aspect of the invention, the aforementioned problem is solved by a transport system for transporting objects along a transport path, the transport system comprising, in this order along the transport path, successively a first transport device or an output processing area, a second transport device according to the preceding descriptions, and a third transport device or a target processing area. By providing a second transport device instead of, for example, the first transport device or the output processing area being arranged adjacent to the third transport device or the target processing area, the aforementioned advantages of such a second transport device can be realized in particular. Accordingly, the risk of a person, an object and/or a device being injured or damaged if the person and/or the object is caught and potentially trapped by a means of transport can be effectively minimized.

In an embodiment of the second aspect, at least one of the first transport device and the third transport device comprises a carrier and a transport means, wherein the transport means is movably mounted on the carrier so that it performs a movement along a defined movement path, wherein the transport means has at least one contact surface which is adapted to contact an object and to entrain it along the transport path.

In a further development of the second aspect, the mounting section of the carrier of the second transport device is connected to the carrier of the first transport device and/or to the carrier of the third transport device. In particular, the carrier of the first transport device and/or the third transport device forms a superordinate structure on which the mounting section of the carrier of the second transport device can hold or support the second transport device. For example, the carrier of the first transport device and/or the third transport device may comprise a holder, which extends in particular into a space between the first transport device or output processing area and the third transport device or target processing area. Preferably, the mounting section of the carrier of the second transport device is connected to the holder in such a way that the second transport device is arranged in the space between the first transport device or output processing area and the third transport device or target processing area.

Advantageously, at least one of the first transport device and the third transport device can be coupled or couplable with the second transport device for transmitting drive movement in order to drive the transport means of the second transport device to move along the movement path. For example, the transport means of the second transport device can be operatively connected to a drive of the first transport device and/or the third transport device via a corresponding coupling. This has the advantages that, in particular if no separate drive has to be provided for the second transport device, it can be designed compactly so that it can also be used in narrow spaces between the first transport device or output processing area and the third transport device or target processing area, and that operation of the second transport device can be controlled together with the first transport device and/or with the third transport device. In particular, a separate control unit is not required for the second transport device. Preferably, a coupling can be realized as described above. The second transport device may have a drive engagement portion which is adapted to engage with an external drive element of the first and/or third transport device to transmit drive force from the external drive element to the transport means of the second transport device. In one embodiment, drive force can be transmitted to the transport means of the second transport device in the form of mechanical force. In particular, the drive engagement section can engage with the external drive element in a force-fit or form-fit manner, for example by means of gears. In a further embodiment, drive power in the form of electrical energy can be transmitted to the transport means of the second transport device.

Preferably, the coupling can be a tooth coupling. A tooth coupling is an effective and safe way of transmitting drive power. In particular, if the first transport device and/or the third transport device comprises a rotating element which is involved in the drive of the corresponding transport means and/or is driven by it, such as a deflection roller at the end of the transport device, a tooth coupling can be operatively connected to this rotating element. In this way, a drive force acting on the first transport means and/or the third transport means, which results in the rotation of the rotating element, can be mechanically transmitted to the second transport device.

Advantageously, the coupling can be set up in such a way that it is disconnected during the evasive movement of the transport means in order to interrupt the transmission of the drive movement. Interrupting the drive movement as part of an evasive movement increases the safety of a transport system according to the invention. For example, a person and/or an object, which and/or which is clamped between the second transport device and the first transport device or the output processing area and/or between the second transport device and the third transport device or the target processing area, may be in engagement with the transport means of at least the second transport device. Each means of transport that is involved in the entrapment and whose means of transport is engaged with the person and/or the object also contributes to the application of force through a drive movement. By interrupting the transmission of the drive movement to the second transport device, the resulting force input is also limited. In particular, a corresponding separation of the coupling has the advantage that the interruption of the transmission of the drive movement to the second transport device takes place automatically with the evasive movement and no additional control is required for the interruption.

In embodiments of the second aspect, a gap between the transport means of adjacent transport devices can preferably be smaller than 15 mm and/or a gap between the transport means of a transport device and an adjacent processing area can preferably be smaller than 15 mm when the transport means of the second transport device moves along the defined movement path, wherein the gap between the transport means of adjacent transport devices can then be greater than 20 mm, preferably greater than 50 mm, when the transport means of the second transport device has performed the evasive movement. A correspondingly close arrangement of neighboring transport means and/or a transport means and a neighboring processing area has the advantage that a transition of objects to be transported across a corresponding intermediate space is facilitated and that the probability is reduced that in particular small parts of objects, such as protruding elements of packaging, get into the intermediate space, are caught there and the object itself is then pulled to the intermediate space and jammed. It also reduces the likelihood of people getting their fingers into the gap, for example.

In an embodiment of the second aspect, a section of the transport path associated with the second transport device has a length that is less than 1 m, preferably less than 0.6 m, particularly preferably less than 0.3 m. In particular, the transport means of the second transport device or the second transport device itself can be dimensioned accordingly compact. Such a compact dimensioning enables, for example, a safe and fast evasive movement of the transport means of the second transport device and/or the second transport device, preferably along correspondingly short release paths, wherein the probability of collisions with and damage to other components of the transport system is also reduced.

### BRIEF DESCRIPTION OF THE DRAWINGS

The invention is explained in more detail below with reference to the drawings. Figures:

FIG. 1: an isometric view of a transport device 1 according to an embodiment of the invention,

FIG. 2: a lateral view of the transport device 1 according to an embodiment of the invention,

FIG. 3: an isometric view of a transport system 2 according to an embodiment of the invention,

FIG. 4: a side view of the transport system 2 according to an embodiment of the invention,

FIG. 5: a side view of the transport system 2 according to an embodiment of the invention, which illustrates the effect of an evasive movement 3.

### DETAILED DESCRIPTION

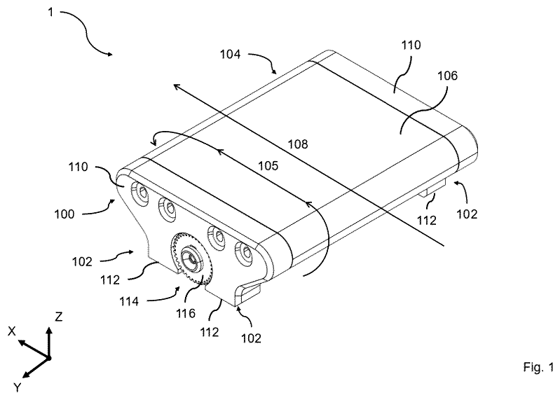

FIG. 1 shows an isometric view of a transport device 1 according to an embodiment of the invention. The transport device 1 comprises a carrier 100 having a mounting portion 102 adapted to hold or support the transport device 1 on a superordinate structure 206, not shown here; a transport means 104 movably mounted on the carrier 100 so as to perform a movement along a defined cyclic movement path 105; wherein the transport means 104 has a contact surface 106 adapted to contact and entrain an object along the transport path 108. In an embodiment example, the carrier 100 comprises two side elements 110, between which the transport means 104 is guided. The mounting section 102 comprises support surfaces 112 on the underside of the side elements 110. In an embodiment example, the transport means 104 is a circulating conveyor belt 104, the movement path 105 of which is defined by at least two spaced deflection means around which the conveyor belt 104 circulates. These deflection means are located inside the transport device 1 and are not shown in FIG. 1. The movement path 105 of the conveyor belt 104 describes an approximately triangular path with rounded corners. The exemplary transport device 1 further comprises a drive engagement portion 114 adapted to engage with an external drive element, not shown here, to transmit drive force from the external drive element to the transport means 104. The drive engagement section 114 comprises here, by way of example, a gear wheel 116 which is operatively connected to a drive shaft 122 of the transport device 1, which is also not shown here.

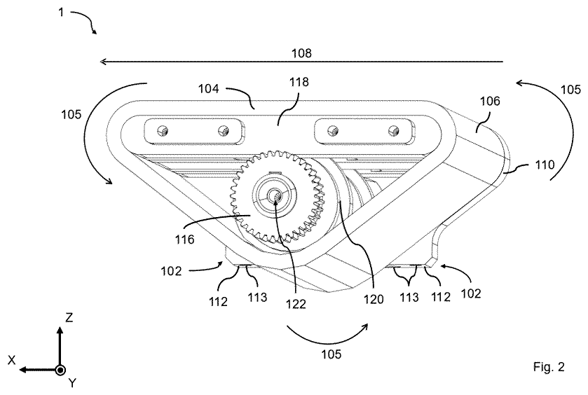

FIG. 2 shows a side view of the transport device 1 according to an embodiment of the invention. In this view, the side element 110, which lies on the side of the gear wheel 116 of the drive engagement section 114, is hidden. One side of the conveyor belt 104, the deflection means, the gear wheel 116 and the drive shaft 122 of the drive engagement portion 114 can be seen in detail here. The deflection means comprise rails 118 with rounded ends, preferably with rollers at the rounded ends, and drive wheels 120, which are operatively connected to the drive shaft 122. The rails 118 are connected to the side elements 110 and preferably form a further part of the support 100. In particular, the rails 118 define an approximately planar portion of the cyclic movement path 105. In particular, the rails 118 support the conveyor belt 104 in this section of the cyclic movement path 105, preferably when a weight force of an object to be transported acts on the conveyor belt 104. Further preferably, the rails 118 support the conveyor belt 104 from below. The drive wheels 120 are in engagement with the conveyor belt 104 to allow drive power to be transferred from the external drive element to the conveyor mean 104. Overall, this results in an approximately triangular movement path 105 of the transport means 104 with preferably rounded corners. The support surfaces 112 can be seen on the underside of the mounting section 102. Magnet arrangements 113 are also provided on the underside of the mounting section 102.

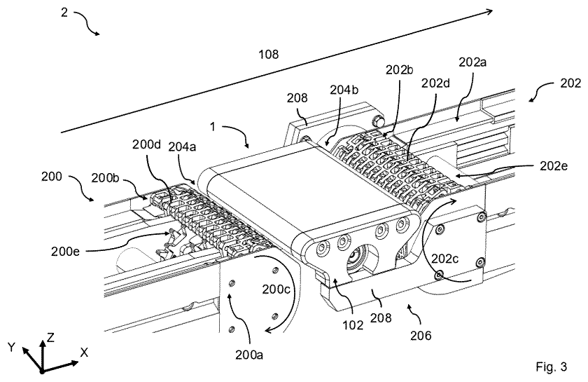

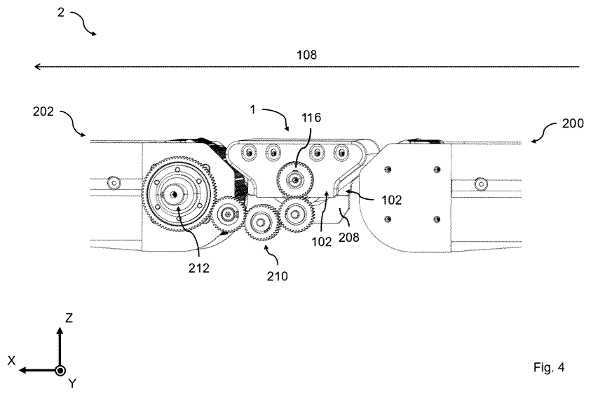

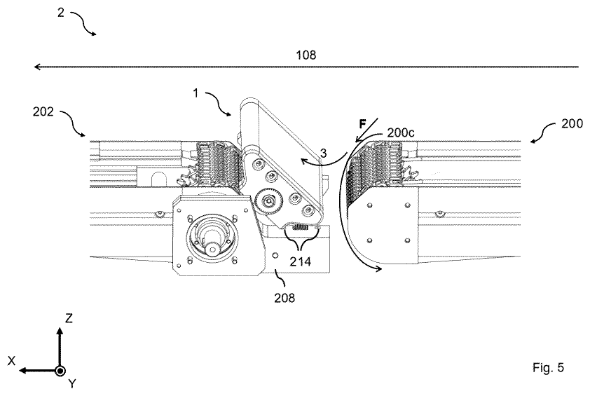

FIG. 3, FIG. 4 and FIG. 5 show an exemplary transport system 2 according to another embodiment of the invention.

FIG. 3 shows an isometric view of the exemplary transport system 2. Shown from left to right are a first transport device 200, a second transport device 1 and a third transport device 202. The second transport device 1 corresponds, for example, to the transport device 1 shown in FIG. 1 and FIG. 2 according to an embodiment of the invention. The first transport device 200 and the third transport device 202 comprise a carrier 200a, 202a and a transport means 200b, 202b, wherein the transport means 200b, 202b is movably mounted on the carrier 200a, 202a so that it executes a movement along a defined movement path 200c, 202c, wherein the transport means 200b, 202b has a contact surface 200d, 202d which is arranged to contact an object and to entrain it along the transport path 108. In this embodiment example, the transport means 200b, 202b of the first transport device 200 and of the third transport device 202 are designed in a chain-like manner, wherein in particular two chain links are articulated to each other along at least one axis, in particular along an approximately horizontal and an approximately vertical axis, which are preferably aligned approximately perpendicular to the transport path 108. In FIG. 3 to FIG. 5, parts of the transport means 200b, 202b of the first transport device 200 and the third transport device 202 are hidden so that other components lying underneath are visible. The carriers 200a, 202a of the first transport device 200 and the third transport device 202 each comprise at the ends of their transportation paths gear wheels 200e,202e which are adapted to engage with the respective transport means 200b, 202b to transmit a driving force to the transport means 200b, 202b and which are adapted to act as a pulley 200e, 202e for the transport means 200b, 202b. The transport path 108 of an object to be transported extends over all three transport devices 200, 1, 202. At the end of the first transport device 200, the object to be transported is transferred to the second transport device 1, at the end of which the object in turn is transferred to the third transport device 202. In particular, a section of the transport path 108 associated with the second transport device 1 has a length that is less than 1 m, preferably less than 0.6 m, particularly preferably less than 0.3 m. The three transport devices 200, 1, 202 are arranged in such a way that the spaces 204a, 204b between the first transport device 200 and the second transport device 1 and between the second transport device 1 and the third transport device 202 are so small that the object to be transported cannot fall into these free spaces during a transition between the transport devices 200, 1, 202. In particular, a gap 204a, 204b between the transport means 200b, 104, 202b of adjacent transport devices 200, 1, 202 is less than 15 mm. A favorable arrangement of the transport devices 200, 1, 202 is achieved in particular by selecting the respective movement paths 200c,105.202c of the transport means 200b,104.202b. At the ends of the first transport device 200 and the third transport device 202, the transport means 200b, 202b each describe an approximately semi-circular path of movement 200c, 202c. The movement path 105 of the transport means 104 of the second transport device 1 has an approximately triangular shape. As a result, the second transport device 1 can be arranged approximately wedge-like between the first transport device 200 and the third transport device 202 and the free spaces between the transport devices 200, 1, 202 can be minimized. A superordinate structure 206 is exemplarily formed as part of the third transport device 202. For this purpose, two holders 208 are attached to the sides of the carrier 202a of the third transport device 202, on which the second transport device 1 is positioned. The mounting section 102 of the carrier 100 of the second transport device 1 is therefore connected to the carrier 202a of the third transport device 202. The second transport device 1 rests with its weight on the superordinate structure 206. This means that the holder 208 of the third transport device 202 carries the second transport device 1. In addition, magnets 214 are provided in particular in the holder 208 of the third transport device 202, which are concealed by the mounting section 102 and are not shown here. These magnets 214 are arranged to interact with the magnet arrangement 113 of the second transport device 1 and to cause a magnetic force which produces an additional holding force. The weight force of the second transport device 1 and this magnetic force together produce a predetermined holding force and thus a predetermined release force.

FIG. 4 shows a side view of the transport system 2 according to an embodiment of the invention. A cover of one of the holders 208 described above is hidden, so that a coupling mechanism 210 is visible, via which the third transport device 202 is coupled to the second transport device 1 for transmitting driving force to the transport means 104. With the aid of the transmitted drive force, the transport means 104 of the second transport device 1 can be driven to move along the movement path 105. This coupling mechanism 210 is here a tooth coupling and comprises gear wheels which are operatively connected to a drive of the transport means 202b of the third transport device 202 via a drive coupling 212. The gear wheel 116 of the drive engagement portion 114 of the second transport device 1 is in engagement with the coupling mechanism 210. Preferably, the magnets 214 of the third transport device 202 are designed and arranged in the holders 208 in such a way that the interaction between the magnet arrangement 113 of the second transport device 1 and the magnets 214 enables precise positioning of the second transport device 1 at a predetermined position. This ensures, for example, optimum engagement between the coupling mechanism 210 of the third transport device 202 and the drive engagement section 114 of the second transport device 1.

FIG. 5 shows a side view of the transport system 2 according to an embodiment of the invention and illustrates by way of example the effect of an evasive movement 3 of the second transport device 1. The cover of the holder 208 hidden in FIG. 4 is shown here, so that the magnets 214 of the third transport device 202 provided in the holder 208 are also shown. A force F has acted on the transport means 104 of the second transport device 1, which has exceeded the holding force caused by the weight of the device and the magnetic force and thus the predetermined release force. This force F may, for example, have been caused by a person and/or an object getting caught on the transport means 200b of the first transport device 200 and, in particular, being pulled along the semicircular movement path 200c thereof at the end of the first transport device 200. The second transport device 1 has been displaced in the direction of the third transport device 202 and tilted in the opposite direction as a result of the application of force F. Accordingly, an evasive movement 3 of the transport means 104 of the second transport device 1 also took place along a release path that deviated from the movement path 105 of the transport means 104. As a result of the evasive movement 3, the distance between the first transport device 200 and the second transport device 1 was increased, so that injury to the person and/or damage to the object and/or components of the transport system 2 was preferably prevented. In particular, the engagement between the gear 116 of the drive engagement portion 114 of the second transport device 1 with the coupling mechanism 210, and thus also the drive of the transport means 104 of the second transport device 1, has also been interrupted. In general, sensors can advantageously be provided, in particular in a transport system 2 according to the preceding descriptions, which are set up to determine whether an evasive movement 3 of the transport means 104 of the transport device 1 according to the invention is taking place, in particular has taken place. In particular, the transport system 2 can be set up to stop a drive of a further transport device 200, 202 of the transport system 2 when an evasive movement 3 occurs, preferably when such an evasive movement 3 is detected by the sensors. In an embodiment example of the transport system 2, for example, a contact sensor is provided in a holder 208, which is set up to detect contact with the mounting section 102 of the second transport device 1, for example when this is positioned as shown in FIG. 3 and FIG. 4. This contact is interrupted by an evasive movement 3, so that the contact sensor detects the evasive movement 3 and, based on this, the drive of a further transport device 200, 202, preferably of all further transport devices 200, 202, is interrupted.

1. Transport device for transporting objects along a transport path, comprising:
a carrier having a mounting portion adapted to hold or support the transport device on a superordinated structure; and
a transport means which is movably mounted on the carrier so that it executes a movement along a defined, cyclic movement path, the transport means having at least one contact surface which is set up to contact an object and to entrain it along the transport path,
wherein the transport device is set up to allow an evasive movement of the transport means along a release path deviating from the movement path of the transport means if a force acts on the transport means which exceeds a predetermined release force.

2. Transport device according to claim 1, wherein the transport means is a circulating conveyor belt, the movement path of which is defined by at least two spaced-apart deflection means around which the conveyor belt circulates.

3. Transport device according to claim 1, wherein the mounting portion is adapted to maintain a holding engagement between the transport device and a superordinate structure when a force acting on the mounting portion is smaller than a predetermined holding force of the mounting portion, and to release the holding engagement when a force acting on the mounting portion is larger than the predetermined holding force of the mounting portion.

4. Transport device according to claim 1, wherein the mounting portion comprises at least one magnet arrangement.

5. Transport device according to claim 1, wherein a holding force of the mounting portion is partially or substantially completely generated by a weight force of the transport device.

6. Transport device according to claim 1, further comprising at least one drive engaging portion adapted to engage with an external drive element to transmit driving force from the external drive element to the transport means.

7. Transport system for transporting objects along a transport path, comprising in the following order, successively along the transport path:
a first transport device or an output processing area;
a second transport device according claim 1; and
a third transport device or a target processing area.

8. Transport system according to claim 7, wherein at least one of a first transport device and a third transport device comprises a carrier and a transport means, wherein the transport means is movably mounted on the carrier, so that it executes a movement along a defined movement path, wherein the transport means has at least one contact surface which is set up to contact an object and carry it along the transport path.

9. Transport system according to claim 8, wherein the mounting portion of the carrier of the second transport device is connected to the carrier of the first transport device or/and to the carrier of the third transport device.

10. Transport system according to claim 8, wherein at least one of first transport device and third transport device is coupled or couplable to the second transport device for transmitting drive motion to drive the transport means of the second transport device to move along the motion path.

11. Transport system according to claim 10, wherein the coupling is a tooth coupling.

12. Transport system according to claim 10, wherein the coupling is arranged such that it is disconnected during the evasive movement of the transport means in order to interrupt the transmission of the drive movement.

13. Transport system according to claim 8, wherein a gap between the transport means of adjacent transport devices is smaller than 15 mm when the transport means of the second transport device moves along the defined movement path, and wherein the gap between the transport means of adjacent transport devices is greater than 20 mm, preferably greater than 50 mm, when the transport means of the second transport device has performed the evasive movement.

14. Transport system according to claim 7, wherein a portion of the transport path assigned to the second transport device has a length that is less than 1 m, preferably less than 0.6 m, particularly preferably less than 0.3 m.
